(19) United States
(12) Patent Application Publication
(10) Pub. No.: US 2004/0153851 A1
(43) Pub. Date: Aug. 5, 2004

(54) System and method for detecting an operationally impermissible configuration

(76) Inventors: Raghavan V. Venugopal, Houston, TX (US); Vinh T. Vuong, Cypress, TX (US)

Correspondence Address: HEWLETT-PACKARD COMPANY, Intellectual Property Administration, P.O. Box 272400, Fort Collins, CO, 80527-2400, US

(21) Appl. No.: 10/340,955

(22) Filed: Jan. 13, 2003

(51) Int. Cl. H04B 1/74

(52) U.S. Cl. 714/43

(57) ABSTRACT

An electronic system includes logic that couples to connectors and receives signals from the connectors. The logic may also detect the presence of an operationally impermissible configuration of said electrical cables based on said signals.

### BACKGROUND

1. Field of the Invention

The present invention generally relates to a computer system. More particularly, the invention relates to the detection of an operationally impermissible configuration in a computer system.

2. Background Information

Many types of electronic systems include electrical cables to connect the electronic system to external equipment, as well as cables used internal to the electronic system itself. It is generally important to connect the electrical cables to the correct connectors—otherwise, undesirable system behavior may result. Personal computers, for example, include a variety of peripheral devices that connect to a chassis containing the system board. Such peripheral devices may include a mouse, a keyboard, a display, speakers, external storage devices, etc. To prevent a user from incorrectly connecting the cables between the various peripheral devices and the chassis, a different type of connector shape and/or size typically is used for each peripheral device. As a result, the keyboard generally can only connect to the keyboard socket on the chassis, the mouse to the mouse socket, the display to the display socket, and so on.

In some applications, it may not be desirable to use different connectors for each device/cable to avoid improper cable connections. In such instances, because a common connector type and size may be used, it is possible to incorrectly connect various devices together. The following subject matter may address this problem.

### BRIEF SUMMARY OF EMBODIMENTS OF THE INVENTION

The problems noted above are solved in large part by an electronic system having logic that couples to connectors and receives signals from the connectors. The logic may detect the presence of an operationally impermissible configuration of the electrical cables based on the signals.

### BRIEF DESCRIPTION OF THE DRAWINGS

For a detailed description of the embodiments of the invention, reference will now be made to the accompanying drawings in which:

FIG. 1 illustrates a computer system including an input/output (“IO”) subsystem in accordance with embodiments of the invention;

FIG. 2 illustrates the various components of the I/O subsystem of FIG. 1 in accordance with various embodiments of the invention;

FIG. 3 illustrates the I/O subsystem of FIG. 2 configured in a simplex mode in accordance with various embodiments of the invention;

FIG. 4 illustrates the I/O subsystem of FIG. 2 also configured in a simplex mode in accordance with various embodiments of the invention;

FIG. 5 illustrates the I/O subsystem of FIG. 2 configured in a duplex mode in accordance with various embodiments of the invention;

FIG. 6 illustrates the I/O subsystem of FIG. 2 also configured in a duplex mode in accordance with various embodiments of the invention;

FIG. 7 illustrates the electrical connections for various pins on an I/O subsystem's back plane connectors in accordance with various embodiments of the invention; and

FIG. 8 illustrates logic usable to process signals from the pins of FIG. 7 to detect operationally impermissible configurations in accordance with various embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or mechanical connection. Thus, if a first device couples to a second device, that connection may be through a direct connection, or through an indirect connection via other devices and connections. The term “operationally permissible configuration refers to a configuration which permits a system containing the configuration to operate properly, all else being equal. By contrast, an “operationally impermissible” configuration does not permit the system to operate properly.

### DETAILED DESCRIPTION OF EMBODIMENTS OF THE INVENTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

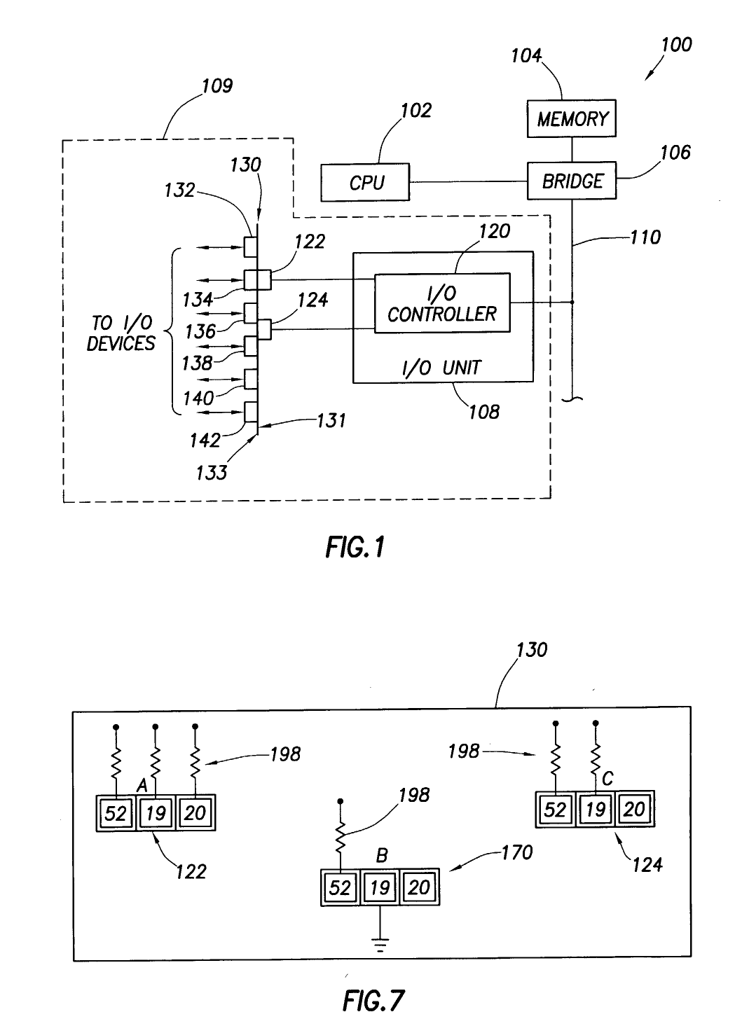

Referring now to FIG. 1, an electronic system 100 may include a central processing unit (“CPU”) 102, a memory 104, bridge logic 106, and an input/output (“I/O”) subsystem 109. The electronic system 100 may comprise a computer or other type of electronic device. The I/O subsystem 109 may include an I/O unit 108 and an I/O back plane 130. The bridge logic 106 may couple together the CPU 102, memory 104, and I/O unit 108. The I/O unit 108 may couple to the back plane 130. One or more I/O devices (not specifically shown) may couple to the system 100 via the connectors 132-142 on one side of back plane 130. Such I/O devices may include storage devices or other types of devices. Other components may be included in system 100, and the components shown in FIG. 1 may be arranged differently.

The back plane 130 may have two sides 131 and 133. As shown, side 131 may include connectors 122 and 124, while side 133 may include connectors 132-142. Electrical cables from the I/O unit 108 may be included to connect to either, or both, of connectors 122, 124. The I/O devices may each connect, via a cable, to one of the connectors 132-142. The back plane 130 thus may function to provide an interconnection mechanism through which I/O devices may be coupled to the I/O unit 108. As shown, the I/O unit may include an I/O controller 120 which may include logic by which the system 100 communicates with the I/O devices. The I/O unit 108 may be provided in the form a circuit board and, without limitation, is referred to below as an “I/O board.”

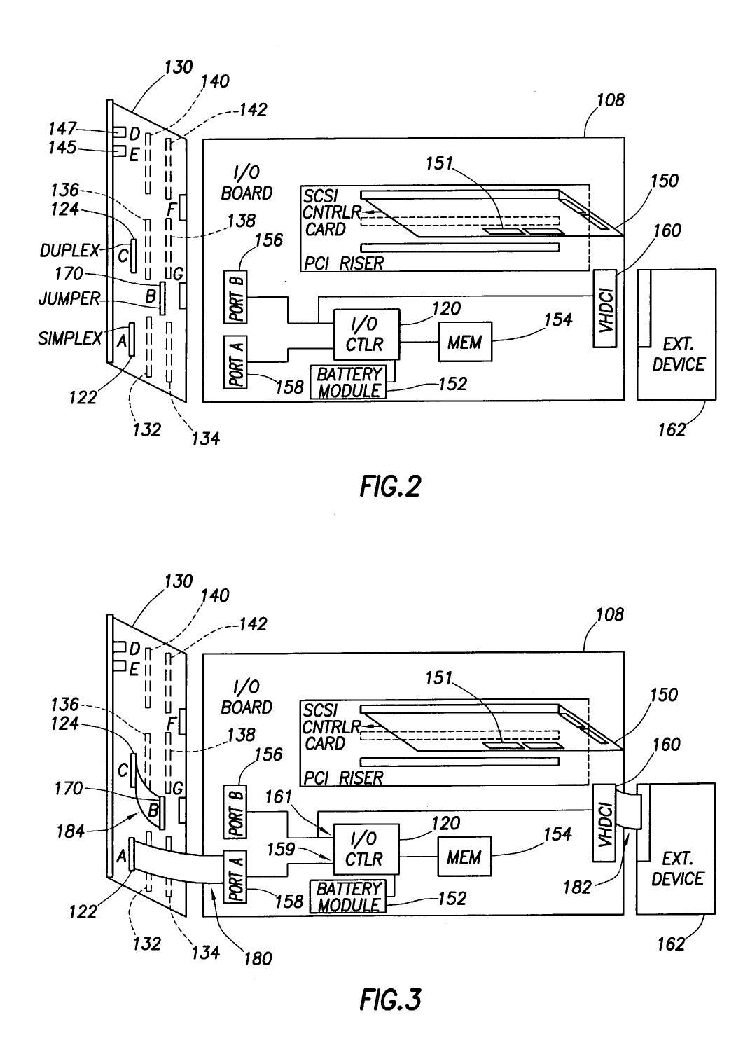

Referring now to FIG. 2, the I/O board 108 may include the I/O controller 120 shown in FIG. 1, an add-in card 150 which may be mated with I/O board 108 and that also may function as a separate I/O controller, a battery module 152, memory 154, and connectors 156, 158, and 160. The back plane 130 may include connectors 122, 124, and 132-142 as discussed above, and also connector 170. Connector 160 on the I/O board 108 may be used to connect an external device 162 (e.g., a storage device) to the computer system 100. Connectors 156 and 158 may be used to connect the I/O controller 120 to one or more of the connectors 122 and 124 which, in turn, may connect through the back plane 130 to one or more of the connectors 132-142, to which various I/O devices may connect.

The battery module 152 may provide battery power to the I/O controller 120 to continue operating even if system 100 is turned off. The memory 154 may comprise any suitable type of memory such as synchronous dynamic random access memory (“SDRAM”). The I/O controller 120 may use memory 154 as temporary storage of data, firmware, and the like. Because the I/O controller 120 may be fixed in place on the I/O card 108, the controller 120 may be referred to as an “embedded” I/O controller.

In some embodiments, connectors 122, 132, 134 and 170 may be wired together. As such, the back plane 130 may permit the operation of two separate I/O busses. Further, connectors 124 and 136-142 may be wired together. Connector 170 may permit various uses. One such use is to tie together connectors 122, 124 and 132-142 to enable one I/O bus using all six I/O connectors 132-142. Controller add-in card 150 may also include a connector 151 which may be connected to either connector 122 or 124 on the back plane 130.

The I/O subsystem 109 may implement any one or more of a variety of interconnect or bus standards. Without limitation, the Small Computer System Interface (“SCSI”) may be implemented within the I/O subsystem 109. As such, controller 120 and 150 may comprise SCSI controllers and connectors 122, 124, 132-142, 150, 156, 158, 160, and 170 may be SCSI compatible connectors. Further still, the I/O devices which may be connected to the back plane connectors may be SCSI-compliant devices.

The various connectors 122, 124, 151, 156, 158, 160, and 170 may be connected in a variety of configurations using various electrical cables. Some of the possible configurations may be operationally permissible, while other configurations may be operationally impermissible. An operationally permissible configuration is one in which the system 100 operates properly, all else being equal. An operationally impermissible configuration is one in which the system, and in particular the I/O subsystem 109, may not operate properly or otherwise may produce unintended system behavior. For illustration purposes and as detailed below, FIGS. 3-6 illustrate at least some of the operationally permissible configurations.

In accordance with various embodiments of the invention, the system 100 may include logic that detects an operationally permissible configuration and distinguishes it from an operationally impermissible configuration. The logic may also respond to the detection of an unacceptable configuration in any suitable manner, such as by illuminating an indicator light or providing a message to CPU 102. The back plane 130 may include one or more indicators. As shown in the exemplary embodiment of FIG. 2, the back plane 130 may include two indicators 145 and 147. As will be discussed below, indicator 145 may be illuminated upon the detection of an operationally impermissible configuration. Indicator 147 may be used to indicate the SCSI bus mode is being implemented on the back plane 130. As will be explained below, one mode may comprise a “simplex” mode in which all of the I/O connectors 132-142 on the back plane are connected to a common bus. Alternatively, a “duplex” mode may indicate that some of the I/O connectors 132-142 are connected to a first SCSI bus, while others of the I/O connectors are connected to a second (separate) SCSI bus.

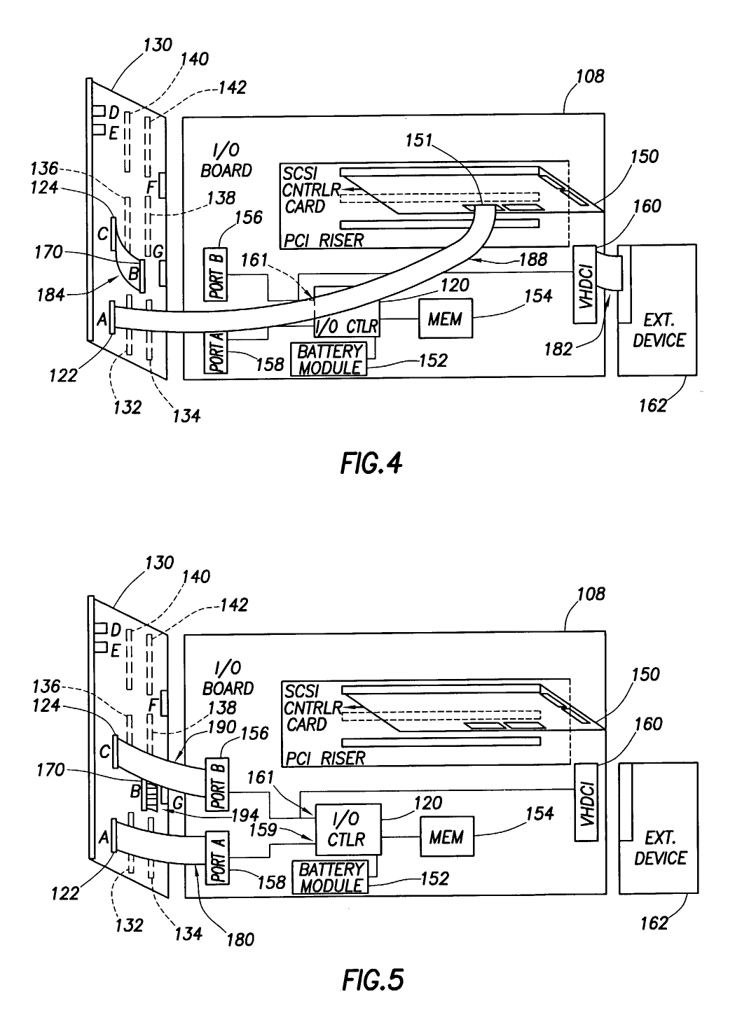

FIGS. 3 and 4 illustrate two exemplary simplex configurations. With respect to FIG. 3, a cable 180, or other type of electrical connection, is made between connector 158 on the I/O board 108 and connector 122 on the back plane 130. A jumper cable 184 may also be used to connect connectors 124 and 170. In this way, all six I/O connectors 132-142 may be wired together and may be driven through connector 158 which couples to a port 159 on the embedded I/O controller 120. The external device 162 may also be connected to connector 160 on the I/O card 108 via a cable 182. As shown, connector 160 may be coupled to port 161 on controller 120. In this configuration, the embedded I/O controller 120 may interact with any I/O device that may be connected to a connector 132-142 on a simplex SCSI bus, and also interact with an external device 162 via a separate SCSI bus.

Referring now to FIG. 4, in other embodiments of the invention a simplex SCSI bus mode may be used. Jumper cable 184 may couple back plane connectors 124 and 170 as discussed above with regard to FIG. 3. In embodiments as illustrated in FIG. 4, the SCSI controller card 150 may drive the simplex SCSI bus on the back plane 130, rather than the embedded controller 120. As such, a cable 188 may connect to connector 151 on card 150 and to connector 122 on the back plane 130. In the simplex SCSI bus embodiment of FIG. 4, while the SCSI controller card 150 drives the multi-device simplex bus through the back plane 130, the embedded controller 120 may be used to interact with the external device 162 via port 161 and cable 182.

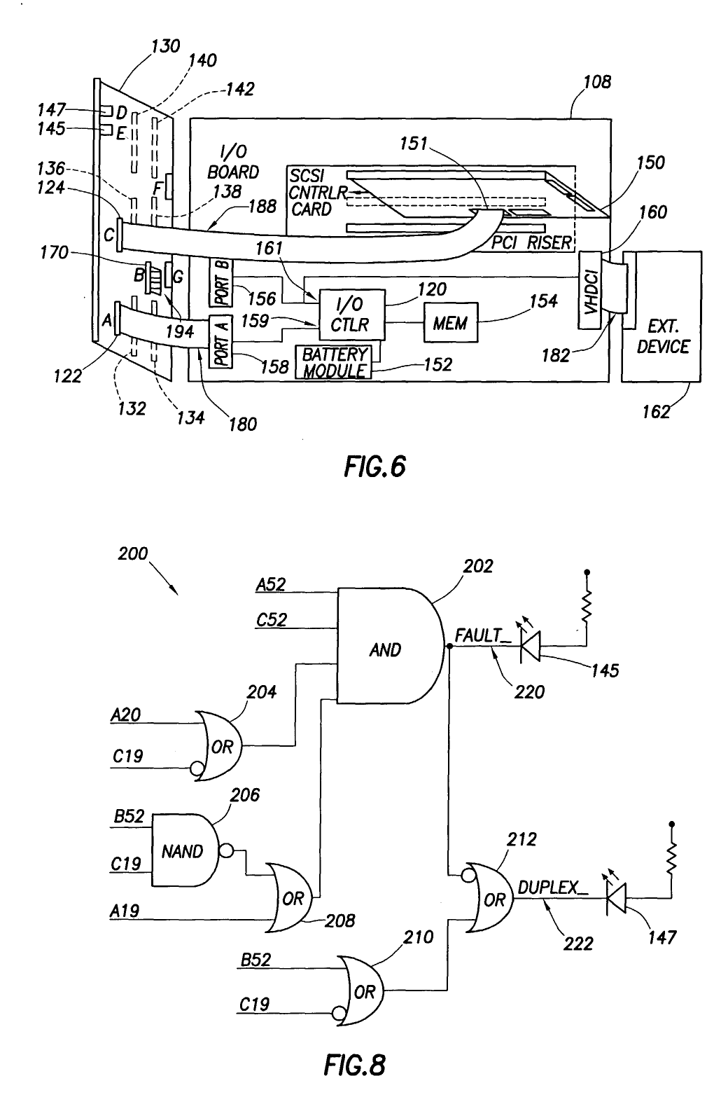

FIGS. 5 and 6 illustrate embodiments in which the SCSI connectors on the back plane 130 are connected in a duplex mode in which connectors 132 and 134 are connected to a first SCSI bus and connectors 136-142 are connected to a second SCSI bus. In FIG. 5, the first SCSI bus (connectors 132,134) may be driven through port 159 of the embedded SCSI controller 120 via cable 180 connected between connectors 122 and 158. Whereas the jumper cable 184 (FIG. 4) may be used to tie together all six back plane 130 I/O connectors 132- 142 in the simplex, in the duplex examples of FIGS. 5 and 6, the jumper cable may not be used to isolate the two sets of connectors. Instead, in FIG. 5 a cable 190 may be included to connect connector 156 from the I/O board 108 to connector 124 on the back plane 130. In this exemplary configuration, the embedded I/O controller 120 may separately control both duplex busses via ports 159 and 161, as shown. A terminator board 194 may be connected to connector 170 to terminate the 1^{st} SCSI bus comprising of connectors 132 and 134.

The configuration of FIG. 6 may be similar to that of FIG. 5. A difference is that the second SCSI bus comprising connectors 136-142 may be driven by SCSI controller card 150 via cable 188 connected between connectors 124 and 151. In this configuration, port 159 of the embedded controller 120 drives the first SCSI bus comprising connectors 132-134 and the add-in SCSI controller card 150 drives the second SCSI bus comprising connectors 136-142. Further, port 161 of the embedded controller 120 may be used for access to the external device 162 via cable 182.

The preceding configurations are intended to exemplify various operationally permissible configurations for the I/O subsystem. Because the connectors 122, 124, 132-142, 151, 156, 158, 160, and 170 may be of the same size and shape, in general it is possible to connect the cables 180, 182, 184,188 in an operationally impermissible configuration. Of course, what is and is not operationally permissible is system specific and thus may vary from application to application. For example and without limitation, jumper cable 184 (FIG. 4) permissibly may be used to connect between connectors 124 and 170, but may permissibly not be used to connect between other pairs connectors such as 122 and 170. By way of an additional example of an operationally impermissible configuration, cable 188 which permits the SCSI controller board 150 to drive a SCSI bus via the back plane 130 should not be used to connect connector 151 to connector 156 or 158. Further still, if the terminator board 194 is used (which is the case for the duplex mode), the terminator board 194 should be mated with connector 170 and no other connector.

FIG. 7, which will be explained in more detail below, illustrates electrical connections pertaining to various pins of connectors 122, 124, and 170. In the exemplary embodiments of FIG. 7, pins 19, 20 and 52 may be used, but other pins may be used as well. With the various pins 19, 20, 52 pulled high, low or unconnected as illustrated in FIG. 7, the various types of cables or terminator board may be configured so as to permit logic (discussed below) to determine if the cables/terminator board have been impermissibly connected. Further, connectors 151, 156, and 158 and terminator board 170 may have their pins 19, 20 and 52 connected as shown in Table I below.

TABLE 1

| | Connector | | Connector | Connector |
|---|---|---|---|---|
| | 151 (SCSI | Terminator | 156 (port 161 | 158 (port 159 |
| Pin | add-in card) | board 194 | on controller 120) | on controller 120) |
| 19 | NC | GND | GND | NC |
| 20 | GND | PWR | NC | NC |
| 52 | PWR | GND | PWR | PWR |

In Table I, “NC” refers to “no connection”, “GND” refers to “ground” and “PWR” refers to “power.” Table I illustrates that connector 151 on the SCSI card 150 may have its pin 19 unconnected, pin 20 grounded and pin 52 pulled high (i.e., connected to a power signal). The terminator board 194 may have its pins 19 and 52 grounded and pin 20 pulled high. Connector 156, to which port 161 of the embedded controller 120 may be connected, has its pins 19, 20 and 52 grounded, unconnected and pulled high, respectively. Finally, connector 158, to which port 159 of the embedded controller 120 may be connected, may have its pins 19 and 20 unconnected and pin 52 pulled high. In general, pins 19, 20 and 52 on connectors 151, 156 and 158 and terminator board 194 are electrically connected differently. As such, logic (described below) may be used to detect an operationally impermissible configuration. As will be explained, the logic processes the signals on pins 19, 20 and 52 of back plane connectors 122, 124 and 170 to distinguish operationally permissible from impermissible configurations.

In accordance with various embodiments of the invention, a plurality of SCSI bus signals may be used to permit the detection of impermissible configurations. In accordance some embodiments as noted above, the signals used may include signals associated with pins 19, 20 and 52, although numerous other combinations of signals may be used as well. Pin 20 is defined in the SCSI standard as being used as a ground signal, while pins 19 and 52 may be unused according the SCSI standard. In accordance with various embodiments, these three pins on each of the connectors 122, 124 and 170 may be pulled high or low or be unconnected in a way that differs from how the same pins are pulled high/low or are unconnected on the other two connectors. FIG. 7 illustrate one possible embodiment. In FIG. 7, the three pins noted above (pines 19, 20 and 52) are shown for each of the connectors 122, 124 and 170 on the back plane 130. With regard to connector 122, all three pins 19, 20 and 52 may be pulled high by pull-up resistors 198. With regard to connector 124, pins 19 and 52 may be pulled high, while pin 20 may be unconnected. For connector 170, pin 52 may be pulled high while pin 19 may be pulled low (i.e., grounded) and pin 20 may be unconnected. In FIG. 7, connectors 122, 170, and 124 are referred to as connectors “A,” “B,” and “C,” respectively, merely for purposes of discussing FIG. 8.

Referring now to FIG. 8, an exemplary logic circuit 200 is illustrated in which the signals from the various pins 19, 20 and 52 from connectors 122, 124 and 170 may be provided. Two output signals 220 and 222 may be generated by logic 200. Output signal 220 may comprise a fault signal (“Fault_”) which may be an active low signal to indicate the presence or absence of an operationally impermissible configuration. The Fault_ signal may be provided to fault indicator 145, which may comprise a light emitting diode (“LED”), whose anode is pulled high. As such, when Fault signal is high, indicating that an operationally permissible configuration is present, the fault indicator 145 may not illuminate indicating such a condition. If, on the other hand, an operationally impermissible configuration is present, the Fault_ signal may be asserted low causing the fault indicator 145 to illuminate.

Logic 200 may also generate an output mode signal 222. In some embodiments, output mode signal 222 may comprise a duplex signal (“Duplex_”) which may be asserted low to indicate the presence of a duplex SCSI bus mode of operation as described previously. If the I/O subsystem is implementing a simplex bus mode, the Duplex_ output mode signal may be driven to the opposite state (i.e., logic high). As such, a logic low state for the Duplex_{— signal 222 may cause mode indicator 147 to illuminate thereby indicating the presence of the duplex mode, while a logic high state for the Duplex signal 222 causes indicator 147 not to be illuminate indicating the presence of the simplex mode. The Duplex}_ mode signal may be asserted when the Fault_ signal is high indicating the presence of a permissible configuration and signal B52 is low and signal C19 is high.

Referring still to FIG. 8, logic 200 may comprise a plurality of logic gates coupled together in such a way to receive the signals from pins 19, 20 and 52 of the three connectors A, B, and C and use those signals to generate the Fault_ and Duplex_ signals 145, 147 as described above. In the embodiment shown in FIG. 8, logic 200 may comprise an AND gate 202, OR gates 204, 208, 210 and 212, and NAND gate 206. Numerous other types and configuration of gates may be used as well.

The signals associated with pins 19, 20 and 52 of connectors A-C are represented in FIG. 8 as signals A19, A20, and A52 for connector A, signals B19, B20, and B52 for connector B, and signals C19, C20, and C52 for connector C. These signals may be provided as input signals to gates 202-210, as illustrated. Signals A20 and C19 may be provided to OR gate 204 (with C19 being provided to an inverting input of the OR gate 204). NAND gate 206 may receive signals B52 and C19 as inputs, while OR gate 210 also may receive signals B52 and C19 as inputs (with C19 being provided to an inverting input of the OR gate 204). Signal A19 and the output signal from NAND gate 206 may be provided as input signals to OR gate 208. The output signals from OR gates 204 and 208 may be provided as input signals, along with signals A52 and C52 to four-input AND gate 202. The output signal from AND gate 202 represents the Fault_ signal 220. The output signals from AND gate 202 and OR gate 210 may be provided as input signals to OR gate 212 and the output signal from the OR gate 212 represents the Duplex_ mode signal.

The logic circuit 200 depicted in FIG. 8 may implement the following Boolean logic expression for the Fault_ signal 220:

Fault_ =A52 AND

C52 AND

A20 OR NOT C19 AND

A19 OR NOT (B52 NAND C19)

According to the above Boolean equation, the Fault_{—} signal may be asserted low if an operationally impermissible configuration is present in the system. For example, if the terminator board 194 is incorrectly mated with connector 122 on the back plane 130 (instead of the preferred connector 170 location, to the extent the terminator board is used), pin A52 on connector 122 may be pulled low because, as shown in Table I above, pin A52 on the terminator board is grounded. In other words, connector 122's pin A52 may normally be pulled high as shown in FIG. 7, but if the terminator board 194 is connected to connector 122, the signal level on pin A52 on the connector will become low. This condition as an input to AND gate 202 may cause the output Fault_ signal 220 of the AND gate to become a low signal, thereby signaling an operationally impermissible condition.

By way of an additional example illustrating the operation of logic 200 in FIG. 8, signal C52 may be provided as an input to AND gate 202. As shown in FIG. 7, this signal normally may be a logic high signal. If the terminator board 194 (which has its pin 52 grounded) is connected to connector 124 (C), pin 52 on the connector may be forced low, again asserting the Fault_ signal low.

By way of yet an additional example, an operationally impermissible configuration may include the SCSI add-in card connector 151 being connected by cable 188 to connector 122 (A) and the terminator board 194 mated with connector 170. Correctly configured, jumper cable 184 may be used in which the SCSI card 150 drives connector 122 to tie together connectors 124 (B) and 170 (C). In the impermissible configuration, pin 20 on connector 122 may be pulled low because pin 20 on connector 151 may be pulled low (see Table I above) from its normally high state (FIG. 7). If jumper cable 184 was in place between connectors B and C, as should be the case for a simplex mode (FIG. 4), pin C19 will be pulled low because pin B19 may be forced low. In the exemplary operationally impermissible configuration in the present example, without jumper cable 184 in place between connector B and C, pin C19 may be at a logic high state because of its pull-up resistor 198 as illustrated in FIG. 7. The output signal from OR gate 204 in FIG. 8 may be at a logic low state, thereby causing AND gate 202's output Fault_ signal to be at a logic low state indicating a fault condition. The output signal from OR gate 204 may also be at a logic low state, indicating a fault, when the SCSI add-in card 150 is connected to connector 122 (A) and neither the jumper cable 184 nor the terminator board are mated with connectors 124, 170.

The combination of NAND gate 206 and OR gate 208 provides logic to detect the following operationally impermissible configurations:

Connectors 156 and 158 may be cross-connected to connectors 124 and 122 on the back plane. That is, instead of, as is shown in FIG. 5, cables 180 and 190 are used to connect connector 156 to connector 122 and connect connector 158 to connector 124 (for the Duplex mode), the cables may be cross connected, thereby connecting port 159 to connector 124 and port 161 to connector 122;

Either connector 156 or 158 may be tied via a cable to connector 122 without a jumper cable 184 or terminator board 194 put in place

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic system, comprising:
a processor;
an input/output (“I/O”) subsystem coupled to said processor, said I/O subsystem providing connectivity to the electronic system by one or more I/O devices, said I/O subsystem also includes a plurality of connectors and one or more electrical cables connected between two or more of said connectors in one of a plurality of configurations, wherein at least one configuration is operationally permissible and at least one configuration is operationally impermissible; and
logic coupled to said connectors and receives signals from said connectors and detects an operationally impermissible configuration of said electrical cables based on said signals.

2. The electronic system of claim 1 wherein each of said connectors include a plurality of pins that are common to all of said connectors, and wherein at least two of said plurality of pins on each connector are encoded differently from the corresponding pins on the other connectors using an encoding technique selected from the group consisting of a pull-up resistor, ground connection, and not connecting the pin to either ground or a voltage.

3. The electronic system of claim 1 wherein each of said connectors include a plurality of pins that are common to all of said connectors, and wherein at least three of said plurality of pins on each connector are encoded differently from the corresponding pins on the other connectors using an encoding technique selected from the group consisting of a pull-up resistor, ground connection, and not connecting the pin to either ground or a voltage.

4. The electronic system of claim 3 wherein the encoded pins provide said signals that are received by said logic.

5. The electronic system of claim 4 wherein said logic asserts a fault signal when said logic detects an operationally impermissible configuration.

6. The electronic system of claim 1 wherein said I/O subsystem includes a terminator board which is connected to one of said connectors in an operationally permissible configuration and wherein said logic detects when the terminator board is connected to another connector in an operationally impermissible configuration.

7. The electronic system of claim 1 wherein said electronic system comprises a computer.

8. An input/output (“I/O”) subsystem usable in conjunction with an electronic system, comprising:
an I/O controller;
a plurality of I/O connectors to which one or more I/O devices connect;
a plurality of I/O controller connectors to which one or more electrical cables connect, said cables also couple to said I/O controller and/or to another I/O controller connector;
said cables capable of being connected in an operationally impermissible configuration or an operationally impermissible configuration; and
logic that couples to said I/O connectors and receives signals from said connectors and detects an operationally impermissible configuration based on said signals.

9. The I/O system of claim 8 wherein each of said connectors include a plurality of pins that are common to all of said connectors, and wherein at least two pins on each connector are encoded differently from the corresponding pins on the other connectors using an encoding technique selected from the group consisting of a pull-up resistor, ground connection, and not connecting the pin to either ground or a voltage.

10. The I/O system of claim 1 wherein each of said connectors include a plurality of pins that are common to all of said connectors, and wherein at least three pins on each connector are encoded differently from the corresponding pins on the other connectors using an encoding technique selected from the group consisting of a pull-up resistor, ground connection, and not connecting the pin to either ground or a voltage.

11. The I/O system of claim 10 wherein the encoded pins provide said signals that are received by said logic.

12. The I/O system of claim 11 wherein said logic asserts a fault signal when said logic detects an operationally impermissible configuration.

13. The I/O system of claim 8 wherein said I/O subsystem includes a terminator board which is connected to one of said connectors in an operationally permissible configuration and wherein said logic detects when the terminator board is connected to another connector in an operationally impermissible configuration.

14. Logic coupled to a host system that receives signals from a plurality of pins in a plurality of connectors, comprising:
a plurality of logic gates coupled together that have inputs and an output, said inputs comprise signals received from said pins and said output comprises a fault signal;
wherein said logic gates process said signals and assert said fault signal if said cables connected to one or more of said signals are connected in a configuration which causes undesirable behavior of said host system.

15. The logic of claim 14 wherein each signal received from said pins has a logic state which is affected by which of said cables connects to the connector having the pin that provides said signal.

16. An electronic system, comprising:
a processor;
an input/output (“I/O”) subsystem coupled to said processor, said I/O subsystem providing connectivity to the electronic system by one or more I/O devices, said I/O subsystem also includes a plurality of connectors and one or more electrical cables connected between two or more of said connectors in one of a plurality of configurations, wherein at least one configuration is operationally permissible and at least one configuration is operationally impermissible; and
a means for receiving said signals from said connectors and detecting an operationally impermissible configuration of said electrical cables based on said signals.

17. The electronic system of claim 16 wherein each of said connectors include a plurality of pins that are common to all of said connectors, and wherein at least two pins on each connector are encoded differently from the corresponding pins on the other connectors using an encoding technique selected from the group consisting of a pull-up resistor, ground connection, and not connecting the pin to either ground or a voltage.

18. An input/output (“I/O”) subsystem usable in conjunction with an electronic system, comprising:
an I/O controller;
a plurality of I/O connectors to which one or more I/O devices connect;
a plurality of I/O controller connectors to which one or more electrical cables connect, said cables also couple to said I/O controller and/or to another I/O controller connector;
said cables capable of being connected in an operationally impermissible configuration or an operationally impermissible configuration; and
a means for receiving signals from said connectors and detecting an operationally impermissible configuration based on said signals.

19. The I/O system of claim 18 wherein said I/O subsystem includes a terminator board which is connected to one of said connectors in an operationally permissible configuration and further including a means for detecting when the terminator board is connected to another connector in an operationally impermissible configuration.

20. A method usable in conjunction with a plurality of connectors to which a plurality of cables can mate, said cables capable of being mated in an operationally permissible configuration which permits proper system behavior or an impermissible configuration which precludes proper system behavior, comprising:
(a) receiving signals from pins on a plurality of connectors; and
(b) using said signals to determine whether an operationally permissible or impermissible configuration is present;
(c) asserting a fault signal if it is determined that an operationally impermissible configuration is present.
